(19) United States
(12) Patent Application Publication
(10) Pub. No.: US 2006/0117337 A1
(43) Pub. Date: Jun. 1, 2006

(54) On-screen intelligent electronic program guide

(75) Inventors: Vishnu Kumar Shivaji Rao, Vancouver, WA (US); Mark G. Hanley, Skamania, WA (US); Gary Feather, Camas, WA (US)

Correspondence Address: ROBERT VARITZ, 4915 SE 33RD PLACE, PORTLAND, OR, 97202, US

(73) Assignee: Sharp Laboratories of America, Inc.

(21) Appl. No.: 11/267,681

(22) Filed: Nov. 4, 2005

Related U.S. Application Data
(63) Continuation of application No. 10/401,943, filed on Mar. 27, 2003.

(51) Int. Cl. H04N 7/16

(52) U.S. Cl. 725/25; 725/38

(57) ABSTRACT

An intelligent, interactively maneuverable interface display of current electronic programming guide (EPG) textual information presentable on a user's television screen. The display, which is organized as a context display, includes keyword-sensitized text, and a virtual, user-employable navigation tool, such as a scrollbar tool, which, via a hand-held remote control device, enables a user quickly, intuitively, and with appropriate user-specific focus to locate programming material of special interest. Display information which is thus accessed by user manipulation of this tool is arranged in a sensible hierarchical manner so as to define different levels of focus-resolution which relate to different “positions” of a handle in the scrollbar tool.

### CROSS-REFERENCE TO RELATED APPLICATIONS

This application is a continuation of currently pending U.S. patent application Ser. No. 10/401,943, filed Mar. 27, 2003, for “On-Screen Intelligent Electronic Program Guide”. The entire prior file history of this application is deemed to be incorporated by reference into this continuation patent application.

### BACKGROUND AND SUMMARY OF THE INVENTION

This invention pertains to a method and a system, and to a resulting interactive display interface, which involve the intelligent display of textual data, drawn from an available electronic programming (EPG) database, in an on-screen display in a user's television receiver. In particular, it relates to such subject matter that pertains to the creation, for use, on the screen of a user's television receiver of a scrollbar-manipulable, pre-selected keyword-activated textual display capable of enabling rapid and sophisticated navigation through various user-interest areas of available television programming.

According to a preferred embodiment of, and manner of practicing, the invention, through the use of a simple remote control device, a user can call up an on-screen interactive display on that user's television screen which presents itself as a scrollbar-driven textual display panel that enables rapid maneuvering through the usual extremely large EPG database. It enables this maneuvering in an intuitive and clearly contextual manner with respect to currently displayed television programming material.

As suggested above, contributions of this invention include both a system and a methodology implementable in the manners just generally outlined, and as well, a unique interactive display interface per se which is intimately related with this system and methodology.

The various features that and advantages that are offered and made available by the present invention will become more fully apparent as the description which now follows is read in conjunction with the accompanying drawings.

### DESCRIPTION OF THE DRAWINGS

FIG. 1 is a high-level block/schematic diagram illustrating both the system and the unique methodology of a preferred embodiment and best mode manner of implementing and practicing the present invention.

FIG. 2 is a fragmentary schematic screen-shot diagram generally illustrating features and the operation of the unique interactive on-screen display which is made available and useable in accordance with practice of the present invention.

FIG. 3 is a story-telling assembly diagram indicating an order, from left to right in FIG. 3, for the reading of a sequence of actions and results pictured in FIGS. 4-9, inclusive, in the drawings.

FIGS. 4-9, inclusive, are simulated television screen shots illustrating operation of the system and method of this invention, and also showing details of the unique interactive on-screen informational display which is provided in accordance with the invention.

### DETAILED DESCRIPTION OF THE INVENTION

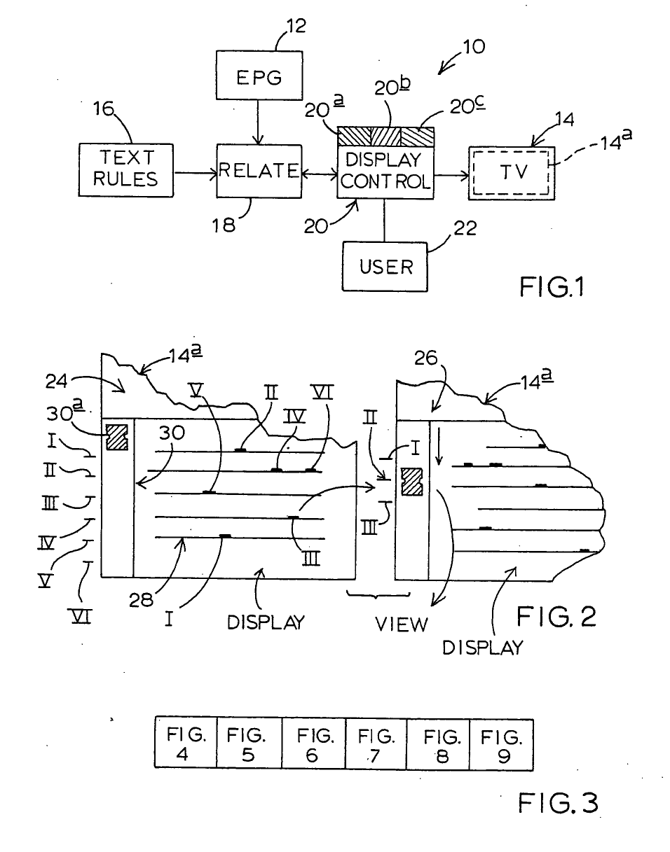

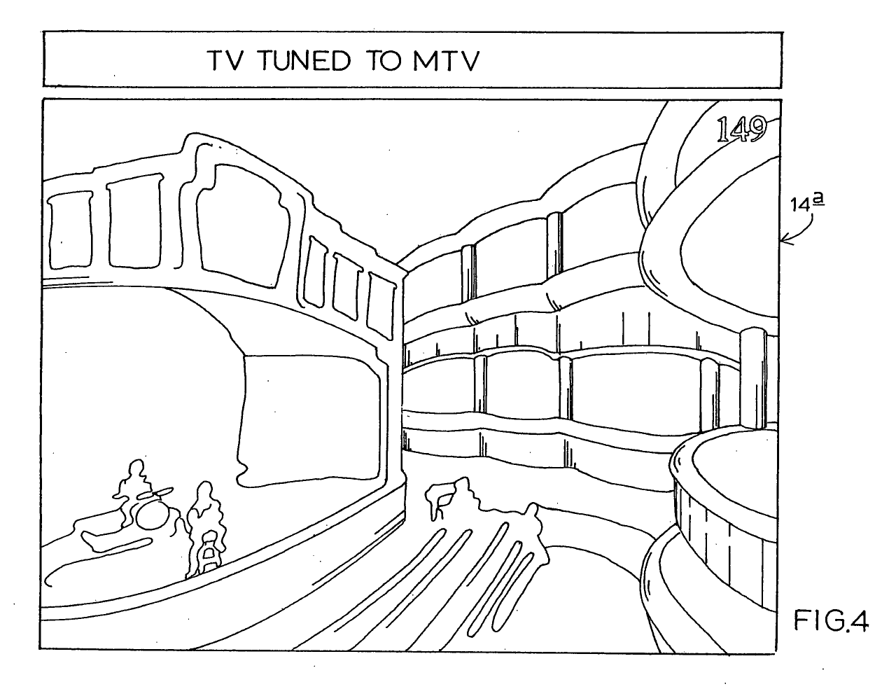

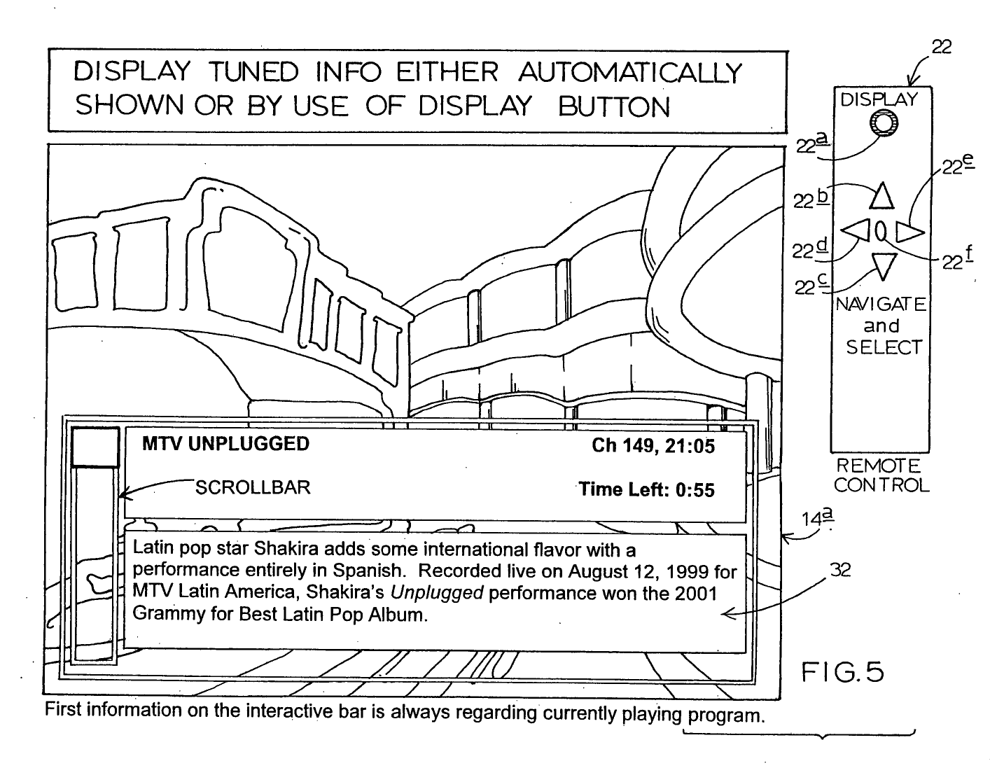

Turning now to the drawings, and referring first of all to FIG. 1, indicated generally at 10, and illustrated in block/schematic form, are a system, and its associated methodology, constructed and operable in accordance with the present invention. It is very common today for television viewers to have connected to their television receivers apparatus and related software which are effective to draw in and make use of, for user/viewer information, regularly broadcast programming information, of a wide categorical variety, via what is known as an electronic programming guide (EPG). This EPG presents a running, and substantially always changing, flow of data containing such programming information covering programming topics, titles, names of personalities, and many other things, and it is normally provided through what is ubiquitously referred to as a “box” that is appropriately connected to receive and provide this database to users who pay for EPG services. In FIG. 1, such a “box” is shown at 12 in the figure, and it is through box 12 that the full available EPG database is made available for interaction with system and methodology 10. Fundamentally, the information which is made available in the EPG database thus provided is textual information, and it is the content of this textual information upon which the present invention relies for its special operational features.

With respect to the usually available EPG database, a “box”, such as box 12, is furnished with appropriate onboard or remote controls that allow a user to call up an on-screen display of available information, with this display appearing generally as a text display in an on-screen window which is presented at some defined location on the user's television screen.

Indicated at 14 in FIG. 1 is a user's television receiver including the usual screen 14a. For the purpose of simplification in FIG. 1, no direct connection is shown between box 12 and receiver 14, though such a direct connection is not necessarily interrupted by introduction of the present invention. In other words, the system and methodology of this invention can be installed for use without necessarily interrupting the opportunity for a user to select, if he or she so wishes, moments or points in time when he or she wishes simply to have the conventional EPG data stream textual display available for observation. FIG. 1, however, is specifically constructed simply to illustrate the unique interposition of system 10 in accordance with the invention in the EPG data stream selectively between box 12 and receiver 14.

Included in system 10 as shown in FIG. 1, and speaking, at least initially, in systemic terms, are devices and related firmware and software illustrated by blocks 16, 18, 20, 22.

Block 16 functions as an appropriately software controlled and managed library of text keywords that are drawn directly from content present, and anticipated nominally to be present, within the broad EPG database made available through box 12.

As will become apparent, various components and procedures which form part of the system and methodology of this invention may individually be, internally, entirely conventional in construction and operation. It is the assembly of these hardware and software components which makes up the present invention. Accordingly, no internal structural and/or software details are presented herein, inasmuch as they do not form any part of the present invention. Those skilled in the art will recognize from the description which now follows that conventional structural and software “building blocks” can easily be employed to assemble and operate the system and methodology of this invention.

Through any one or more of conventional text analyses structures and algorithms, block 16, which may initially constitute a preliminarily created library of expected textual content drawn from the conventional EPG data stream, is equipped effectively to “mine” the current active EPG database in its entirety to select, and to add to its content, new and additional keyword content. It is intended that the word content which characterizes block 16 will act effectively as a body of text keywords which are not specifically shown to the user, but which function, as will be explained, to enable user/viewer navigation through the EPG database for the purpose of learning about and selecting various kinds of programming.

Thus, block 16 is a library, which may be a dynamically changeable library, of words present in the EPG database, which words are characterized, in accordance with practice of the invention, as active keywords. Additionally the software associated with the creation and operation of the body of information content within block 16 performs the additional function, dynamically, of noting within the entirety of the currently available EPG database how many occurrences, uses or appearances of each libraried keywords then exist throughout and within the EPG database.

From this information, there exists an internal hierarchy, so-to-speak, relating to the depth or volume-number of references to selected keywords existing at any moment in time in the entire EPG database. For example, there might, at some point in time, be, say, one hundred references to the name of actor A, thirty-four references to actor B, and sixty-one references to actor C. Hierarchically, and the significance of touching on this point will be explained shortly, the hierarchical order which will be assigned, in a relative sense, to actors A, B and C will be in the order of actor B, actor C and then actor A. In other words, the hierarchy thus expressed is one wherein, at the pinnacle of the hierarchy resides that keyword actor name which has the fewest number of references in the EPG database, and at the base of the hierarchy, will be the actor name which has the largest number of occurrences, at that point in time, in the EPG database. This hierarchical arrangement is not necessarily, nor preferably, organized in terms of categories, say, of actors, of action styles, of types of sports events, etc., but rather, is arranged with respect to relating all keywords in all categories within block 16.

What this means, for example, is that at the pinnacle of hierarchy at a particular moment in time might be a particular actor's or actress' name, and at the base of the hierarchy might be a type of sporting event. Intermediate these two there may always be an unpredictable blend, mix and order of categories, with the order being entirely dependent upon the number of occurrences/references then employing these keywords throughout the entire EPG database.

Block 18 in system 10 functions as a relationship locating block which is operatively connected, as shown, to blocks 12, 16 and 20. Block 18 functions, when system 10 is in use, to create an association between the currently available total EPG database, and the keyword information which is stored in block 16. It makes this comparison so as to make available to block 20, referred to herein as a display control, a modified version of the full EPG database, wherein, though not made expressly visible to the user/viewer, but nevertheless present, are words that are displayable in text on the user's screen which are also in the body of information within the EPG database. Thus, the display control block is, in effect, furnished with an EPG data stream wherein words that are content in that data stream are recognized by the system of this invention as being keywords with a certain hierarchical relationship relative to one another.

As can be seen in FIG. 1, display control block 20 is operatively connected to television receiver 14, and also to blocks 18, 22 in system 10. Block 22 may be any suitable form of a user/viewer control device, and herein takes the form of an otherwise conventional wireless remote control unit. Control unit 22 is, of course, specifically furnished in accordance with the present invention with the appropriate controls for allowing user operation of system 10.

Display control block 20 is preferably made up of conventional building blocks of structure and software which characterize three structural/operational components, or zones, that are shown as three differently shaded rectangles at the upper side of block 20 in FIG. 1. These zones are referred herein respectively, as a first structure 20a, a second structure 20b, and a third structure 20c.

In general terms, and during operation of system 10, first structure 20a functions within the display control to enable what is referred to herein as the selective creation of an on-screen interactive display of EPG textual information. More will be said about the nature and operational character of this display shortly.

Second structure 20b, which is appropriately operatively connected to first structure 20a, operates, in conjunction with the display-creating activities of structure 20a, to place what is referred to herein as a user-maneuverable change-condition virtual tool in the display thus created on screen 14a. As will be seen shortly, the preferred tool thus created by structure 20b takes the form of a scrollbar-like virtual tool.

Third structure 20c is operatively and appropriately connected to structures 20a, 20b, and is designed to cooperate with these two structures in a manner whereby it enables user maneuvering and manipulating of the virtual tool created by structure 20b in what are referred to herein as different selectable modes of maneuvering through and within displayed EPG textual information.

As will also be explained shortly, one mode of maneuvering enabled by structure 20c is one which effects textual changes in the information content of a created display, where such changes have what is referred to herein as both a commonality and a hierarchical functional relationship relative to one another and with respect to the textual content which is presented in the window at the time of implementation of this mode of maneuvering. A commonality relationship is that which is based upon the fact that the information presented via maneuvering is related directly to different pieces of information content all commonly presented in a single on-screen display of text at the time that maneuvering take place. The hierarchical relationship relates to the hierarchy of keyword information described earlier with respect to block 16, and specifically relates to the manner in which maneuvering of a scrollbar handle upwardly and downwardly, as is the case in the preferred embodiment of the invention, progressively introduces the user viewer to information in a hierarchical fashion whereby, with a scrollbar handle positioned near the top of a vertical scrollbar tool display, the information provided to the user is that information drawn from content then in the display window which has the fewest number of occurrences or references then in the current EPG database. As the user maneuvers the scrollbar handle downwardly in the display, successively larger hierarchical categories of information are presented.

As an illustration, with the toolbar handle at a high location, the user might be presented with information describing two or three particular films in which a certain actress is known to be performing. At a lower position for the scrollbar handle, the user might be provided with information about the fact that another actor is known to be cast in, say, several dozens of films, adventures, etc. Near the bottom of toolbar handle positioning, the user might at this point be exposed to the fact that there are several hundreds of sports, documentaries, etc., that are referenced then in the EPG database.

Another mode of user/viewer maneuvering which is enabled by third structure 20c is a viewing selectability mode, wherein a user, having maneuvered the mentioned scrollbar handle to a point of interest to that user, “clicks” on the scrollbar handle at a point where the information of special interest is then displayed. This action effects either an immediate retuning of the television receiver to receive the selected programming content, or if that programming content is simply being announced for future viewing, it may result in a response, which may be a feature if desired of the present invention, to create memory storage of user selection for future reference or automatic turning-on and tuning-in of the user's television receiver.

FIG. 2 helps further to illustrate the system and methodology of this invention. In FIG. 2, two side-by-side and somewhat different views of television screen 14a are provided. In these views, two different on-screen user interface displays 24, 26 are generally shown.

Referring first of all to the left side of FIG. 2, with a particular program tuned-to and viewable on screen 14a, the user operates control 22 to bring up an initial on-screen display under the control of system 10. This on-screen display is what is labeled 24 in this left-side view in FIG. 2. As can be seen, display 24 takes the form generally of a window which contains a body of text in different lines of text 28, which text, but not directly visible to the user/viewer (i.e., non-highlighted), contains a distribution of different keywords which are shown as small dark rectangles. These keywords are labeled with the Roman numerals I-VI, inclusive. The display of lines of text in text body 28, and the scattered distribution of the mentioned, but non-highlighted keywords, is somewhat random, but, of course is in accordance with the display of text carried then in the EPG database. In other words, exactly what the contents of the lines of text are, and where the keywords reside, is dependent upon the EPG database. The fact that certain words are to be treated as keywords is a result of interaction of the EPG database in block 18 with the contents of block 16 in FIG. 1.

This, then, is an opening display, and in accordance with practice of the invention, this opening display is that which contains information specific to the programming material which is then presented on screen 14a. Included in display 24, and disposed toward the left side of the display, is a virtual scrollbar tool 30 with a vertically “moveable” handle 30a created there by the operation of previously mentioned structure 20b. As will be explained, with scrollbar tool 30 thus presented, the user is enabled, through control 22, to maneuver and manipulate handle 30a downwardly and upwardly in the display to different positions, each of which calls up a changed display based upon keywords then present in the on-screen display text. These different displays appear in the order of hierarchy assigned to the associated keywords.

As an illustration, to the left of scrollbar 30 on the left side of FIG. 2, are six different “handle positions”, which are numbered with Roman numerals Ia-VIa, inclusive. These enumerated scrollbar handle positions are intended to relate, respectively, to keywords I-VI, inclusive. One will notice that the distribution of keywords bearing Roman numerals is not in any particular prearranged order within the display now being discussed. The assignment of Roman numerals to these keywords as presented is intended to reflect the fact that there is a hierarchy of relationships between these keywords, with the keyword which bears Roman numeral I lying at the top of that hierarchy, and the keyword associated with Roman numeral VI being lower in the hierarchy. Thus, as the user maneuvers handle 30a downwardly in scrollbar 30, passing successively through these six different Roman-numeraled positions, information is presented in a changed condition on the screen with respect to each of these positions that relates to the specific keyword which is associated with that position. Thus, the user is enabled to navigate through the EPG database in a contextual way which commonly relates all of keywords I-VI, inclusive, in the sense that they are all present in the display which is pictured in the display on the left side in FIG. 2. Such navigation also occurs in accordance with a hierarchical functional relationship between the associated keywords.

Looking to the right side of FIG. 2, and assuming that the user/viewer has maneuvered scrollbar handle 30a to position IIa, one will see that the appearance of the display has now changed to a different appearance which reflects display 26. Display 26 is the display that is associated with the user's having maneuvered handle 30a to hierarchical position IIa downwardly along the scrollbar. One can see by making a quick visual comparison between the left and right sides in FIG. 2 that the arrangement of text and lines of text, and the distribution of keywords in that text (not specifically highlighted for visibility to the user) have changed.

Thus it is that the present invention enables versatile intuitive user maneuvering in an intelligent way through the vast information constantly made available by the usual broad-based EPG database.

From the discussion which has just been given, a look now in serial order through and including FIGS. 4-9, inclusive, should be quite self explanatory.

FIG. 4 represents a full screen shot of a current broadcast to which receiver 14 is tuned. It is shown tuned to “MTV” on a channel numbered 149.

In FIG. 5, one form of a control unit 22 is shown at the right side of this figure. This control includes a display activating button 22a, up and down maneuvering buttons 22b, 22c, respectively, left and right maneuvering buttons 22d, 22e, respectively, and a “click” entering button 22f. By depressing button 22a in FIG. 5, the user calls up an initial on-screen display 32 prepared in accordance with practice of the present invention. This display contains text relating to the currently viewed program, provides a certain amount of ancillary information such as channel, current time of day, and time left for broadcast, and also presents the previously described user-maneuverable virtual scrollbar tool which is seen clearly at the left side of FIG. 5. The handle in the tool is positioned at the top of the vertical band which represents the scrollbar. Text within the display of FIG. 5 is un-highlighted, but it does contain certain selected keywords which have been selected in accordance with operation of system 10 as described earlier herein.

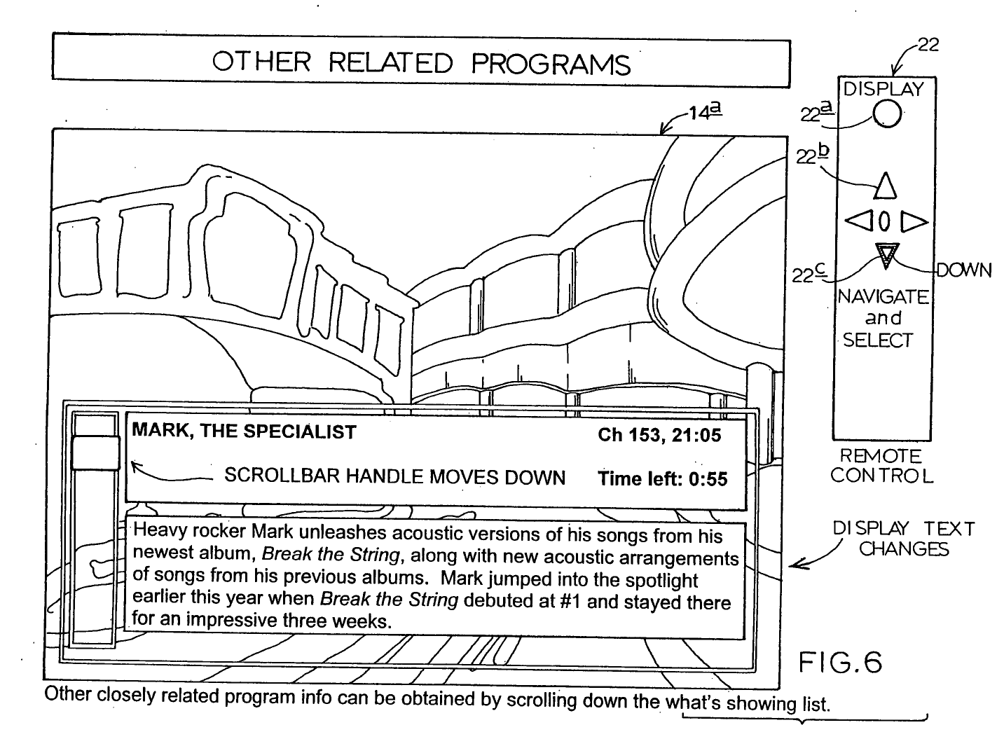

By using the up and down maneuvering buttons provided in control unit 22, the user causes the handle in the scrollbar to shift vertically, such as downwardly somewhat to the position shown for it in FIG. 6. In this position, some aspect of the keyword text information contained originally in the display of FIG. 5 changes to furnish the viewer with the contextually related new information, such as that clearly seen in the interface display as pictured in FIG. 6.

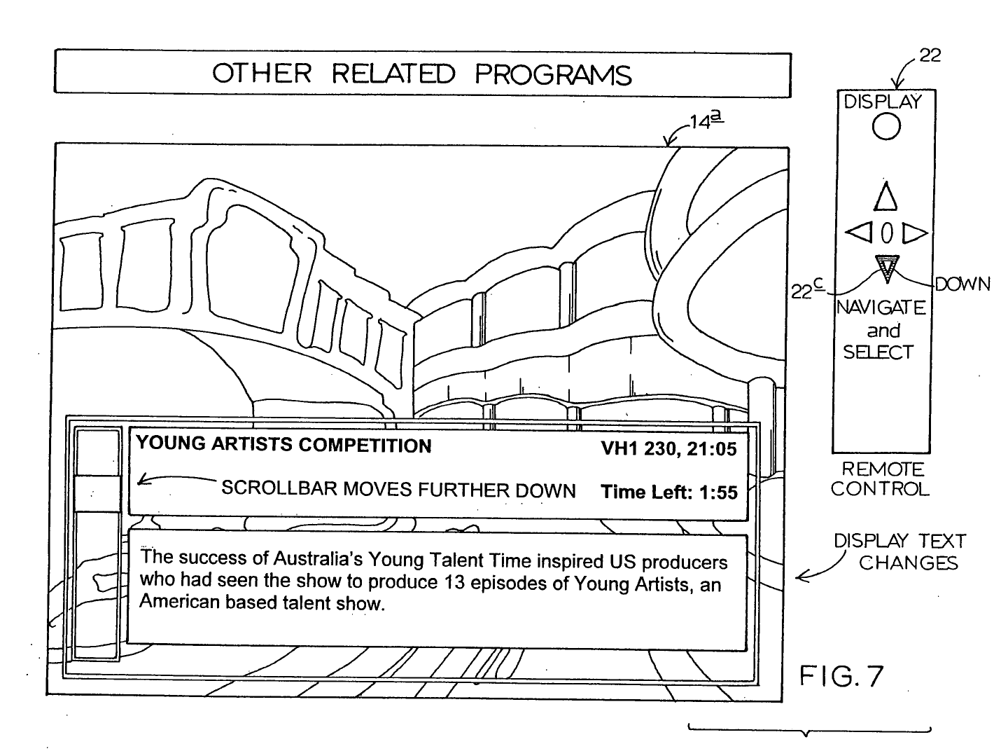

In FIG. 7, one sees that the user here has further maneuvered the scrollbar handle downwardly to another contextual offering which is lower in the hierarchical list.

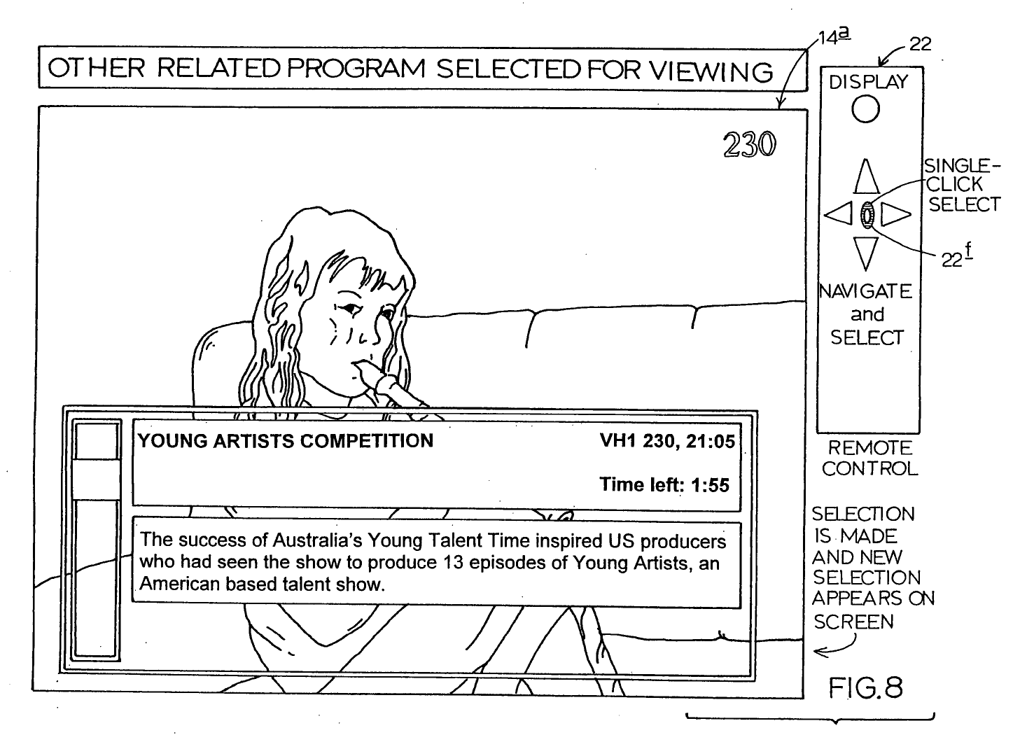

In FIG. 8, the user has selected for viewing the specific content presented in FIG. 7. This selection is performed by single-clicking (effectively) “on” the handle bar position shown in FIG. 7, by depression of button 22f.

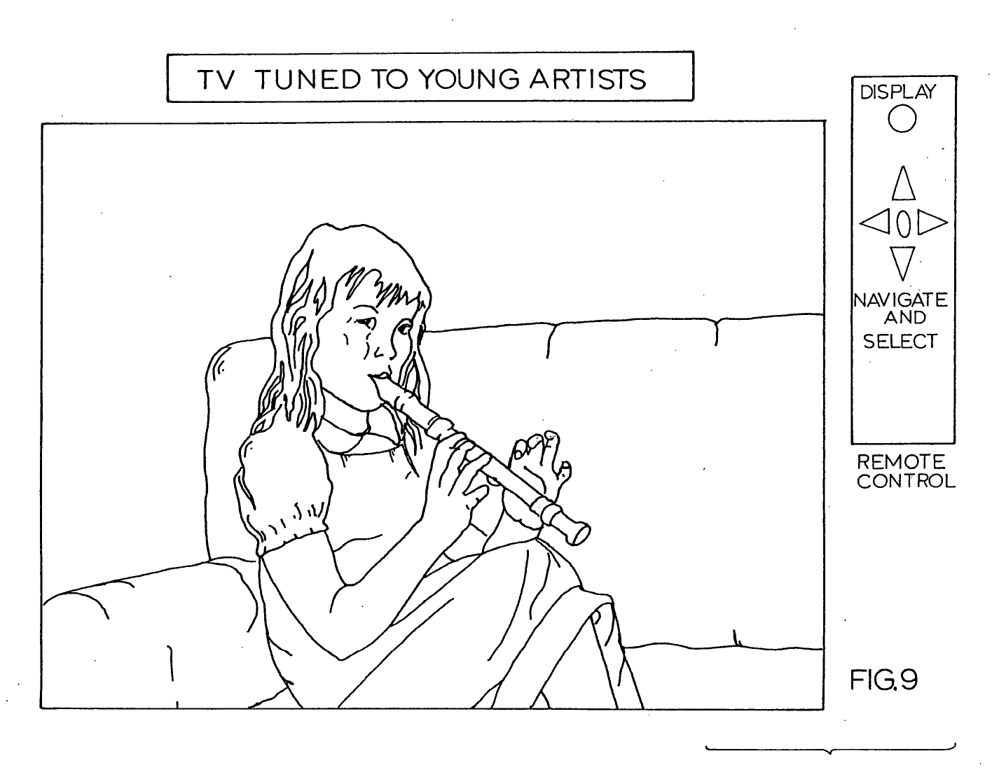

FIG. 9 represents now completed tuning of receiver 14 to the selection made from the display of FIG. 8. The on-screen display of this invention disappears (has disappeared).

Thus, the system and methodology of the present invention operate to furnish an intelligent and interactively maneuverable display of current EPG textual information, with this information presented as a display in a window on the user's television screen. The presented display produced in accordance with the invention contains a body of text relating to EPG information, and it enables, via a change-condition virtual maneuvering tool (the scrollbar and handle tool), different modes of interaction to navigate through the EGP database. Use of the system and methodology of the invention do not require any complicated menu interaction by a user, nor do they require the entry, as by keypad actuation, of any letters or numbers to select and locate EPG information.

While not necessarily a component in all implementations of the invention, a modified form of system may include suitable controls and software to enable user selection of a future programming offering to create an active memory condition which can automatically turn-on and tune-in a user's television receiver. Additionally, and while it is entirely possible to implement the system and methodology of this invention in a entirely satisfaction with the content of library block 16 being completely pre-selected, it is preferable that this block be appropriately equipped to perform dynamic “mining” of currently available EPG information so as to keep current in this block the most appropriate current body of active textual keywords. Additionally, it is certainly possible to furnish a modified form of the system in which a user is given certain preference-setting access to the keyword database contained in the library.

Accordingly, while a preferred embodiment and manner of practicing the invention have been described herein, and certain variations and modifications suggested, other variations and modifications are recognized to be possible, and all such variations and modifications are considered to be within the scope of the present invention.

We claim:

1. An intelligent and interactively maneuverable interface display of current electronic programming guide (EPG) textual context information drawn from an ever periodically changing, currently available EPG database, and presentable as a narrative-statement-format display on the screen in a user's television receiver providing information regarding the currently viewed program comprising
a display window,
a body of current EPG paragraph text set forth in said window in the above-mentioned narrative-statement format and containing certain television program information which is presently contextually related to the currently displayed program and which contains present keywords organized into an unseen hierarchy of keywords based upon relative population numbers thereof in the current EPG database, with the respective population number for each keyword being determined by the number of other programs currently referred to in the EPG database having associated EPG texts which contain that keyword, and with the pinnacle of the hierarchy being represented by the keyword having the lowest current population number and the base of the hierarchy being represented by the keyword having the highest current population number, such present context and hierarchy being unpredictably and changeably determined by the real-current-time confluence of (a) currently chosen and displayed program material, (b) currently established EPG descriptive narrative associated with such chosen program material, and (c) currently available information distributed throughout the current EPG database, and
a virtual change-condition maneuvering tool also appearing in said window, enabling user-interactive maneuvering, in different user-selectable modes, to initiate (a), in one mode of interactive maneuvering, sequential changes in the textual information content of the window, where such changes have both commonality and hierarchical functional relationships relative to one another and with respect to the textual content which is presented in the window at the time of implementation of said one mode, with the commonality relationship being based upon the mentioned contextual relationship, and the hierarchical relationship being directly associated with the mentioned relative population numbers hierarchy regarding the text-contained keywords, and with the sequence of possible changes in textual content being solely determined by the confluence mentioned above, and independent of any user selection, and (b), in another mode of interactive maneuvering, user selectability, for user viewing, of the specific selectable programming material then associated with the EPG text presented at that time in said display window.

2. The interface display of claim 1, wherein (1) said commonality relationship is one further involving the fact that the keywords in the then-presented EPG text have been pre-assigned an EPG-internal, topical, navigational role, whereby the presence of such a word in the displayed text acts as a definer of a specific region of EPG information to make available to a user during at least one phase of maneuvering said tool in said one mode, and (2) said hierarchical relationship is one further involving the relative volumes and/or depths of such defined, specific regions which have pre-assigned respective associations with different ones of such certain content words.

3. The interface display of claim 2, wherein such pre-assignment relative to a keyword is invisible in said display.

4. A method for enabling user interactive maneuvering, within a television receiver on-screen display, of and with respect to currently available electronic programming guide (EPG) textual information which is drawn from the currently available EPG database, and which is presented in that display, said method comprising
enabling the selective creation of such an on-screen display which is contextually related to currently displayed programming material and which contains keywords organized into a hierarchy of keywords based upon relative population numbers thereof in the current EPG database, with the pinnacle of the hierarchy being represented by the keyword having the lowest current population number, and the base of the hierarchy being represented by the keyword having the highest current population number,
placing a user-maneuverable, change-condition virtual tool in that display, and
creating a condition which allows a user to maneuver that tool in different selectable modes of maneuvering, one of which modes initiates changes in the textual information content of the window, where such changes have both commonality and hierarchical functional relationships relative to one another and with respect to the textual content which is presented in the window at the time of implementation of such one mode, with the commonality relationship being based upon the mentioned contextual relationship, and the hierarchical relationship being directly associated with the mentioned relative population density hierarchy regarding the text-contained keywords, and the other of which modes effects user selectability, for user viewing, of the specific selectable programming material then associated with the textual information currently presented in the window.

5. A system for enabling user interactive maneuvering, within a television receiver on-screen display, of and with respect to currently available electronic programming guide (EPG) textual information which is drawn from the currently available EPG database, and which is presented in that display, said system comprising
first structure enabling the selective creation of such an on-screen display which is contextually related to currently displayed programming material and which contains keywords organized into a hierarchy of keywords based upon relative population numbers thereof in the current EPG database, with the pinnacle of the hierarchy being represented by the keyword having the lowest current population number and the base of the hierarchy being represented by the keyword having the highest current population number
second structure operatively connected to said first structure, operable to place a user-maneuverable, change-condition virtual tool in that display, and
third structure operatively associated with said first and second structures, constructed to allow a user to maneuver that tool in different selectable modes of maneuvering, one of which modes initiates changes in the textual information content of the window, where such changes have both commonality and hierarchical functional relationships relative to one another and with respect to the textual content which is presented in the window at the time of implementation of such one mode, and the other of which effects user selectability, for user viewing, of the specific selectable programming material then associated with the textual information currently presented in the window.
